(19) United States
(12) Patent Application Publication
(10) Pub. No.: US 2015/0007280 A1
(43) Pub. Date: Jan. 1, 2015

(54) WIRELESS PERSONNEL IDENTIFICATION SOLUTION

(71) Applicant: Andrew Carlson, New Brighton, MN (US)

(72) Inventor: Andrew Carlson, New Brighton, MN (US)

(21) Appl. No.: 14/316,601

(22) Filed: Jun. 26, 2014

Related U.S. Application Data
(60) Provisional application No. 61/839,650, filed on Jun. 26, 2013.

(51) Int. Cl. H04L 29/06; G06F 21/35

(52) U.S. Cl. CPC H04L 63/0853; G06F 21/35
USPC 726/5

(57) ABSTRACT

A system and method for wirelessly identifying users of electronic equipment and making decisions about access and authorization to the electronic equipment through the use of Key Devices.

### CROSS-REFERENCE TO RELATED APPLICATIONS

This application claims the benefit of U.S. Provisional Application No. 61/839,650, filed Jun. 26, 2013, titled WIRELESS PERSONNEL IDENTIFICATION SOLUTION.

### BACKGROUND OF THE DISCLOSURE

Electronic devices frequently contain access limitations for all users accept for those who are given permission to use the devices. The present invention relates to a system and method wherein wireless technology streamlines and simplifies the identification of users in a variety of situations.

### SUMMARY OF THE INVENTION

This system is composed of components that use wireless technology to streamline and simplify identification of users in a variety of situations. Decisions about access and authorization can be made by monitoring the location of Key Devices.

### BRIEF DESCRIPTION OF THE DRAWINGS

FIG. 1 illustrates several types of credentials available in the disclosed invention.

FIG. 2 illustrates Protected Resources available in the disclosed invention.

FIG. 3 illustrates one example of the disclosed process in use.

FIG. 4 illustrates the process flow for application and resource protection in one embodiment of the disclosed invention.

FIG. 5 illustrates a remote access process flow in one embodiment of the disclosed invention.

FIG. 6 illustrates one embodiment of a physical access control for the disclosed invention.

FIG. 7 illustrates a user identification process flow in one embodiment of the disclosed invention.

FIG. 8 illustrates a schematic block diagram of an example computing system.

### DETAILED DESCRIPTION

Various user interfaces and embodiments will be described in detail with reference to the drawings. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover applications or embodiments without departing from the spirit or scope of the claims attached hereto. Also, it is to be understood that the phraseology and terminology used herein are for the purpose of description and should not be regarded as limiting.

This system is composed of components that use wireless (Bluetooth, NFC and Wifi) technology to streamline and simplify identification of users in a variety of situations. Decisions about access and authorization can be made by monitoring the location of Key Devices 102.

The User 104 is critical in this access control design. Users 104 carry the Key Device 102 with them at all times, and know the credentials (username and password) required to verify and validate their identity.

The Key Device 102 is a wireless-enabled device (frequently a mobile device or beacon) that has been paired with a trusted, secured system. Key Devices 102 serve as an additional credential, proving that the User 104 requesting access has a trusted device, along with other required credentials.

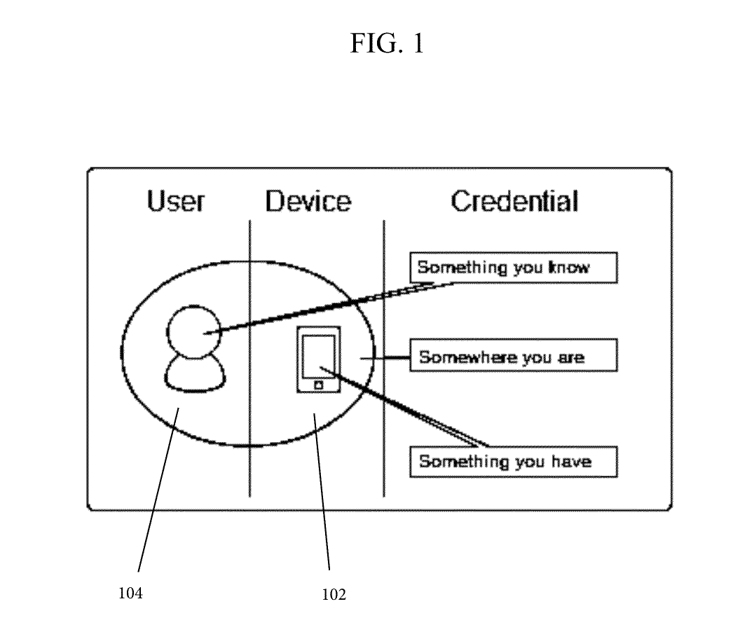

Users 104 must supply credentials to the systems they wish to access. Requirements may vary depending on the resource and policy governing access to it. There are several types of credentials available in this design including, but not limited to, presence, password, one time password (OTP), certificate, and multiplex, as illustrated in FIG. 1. For example, detection of the Key Device 102 when it is near the trusted system may suffice as a credential; passwords or passphrases may be required from the User 104 or may be configured automatically into the Key Device 102 to Trusted Device communication; OTP codes may be transmitted automatically between the Key Device 102 and Trusted Devices or rendered for the User 104 to enter manually; or Key Devices 102 can be configured to store and transmit certificate keys. More than one type of credential may be required for access to any given system.

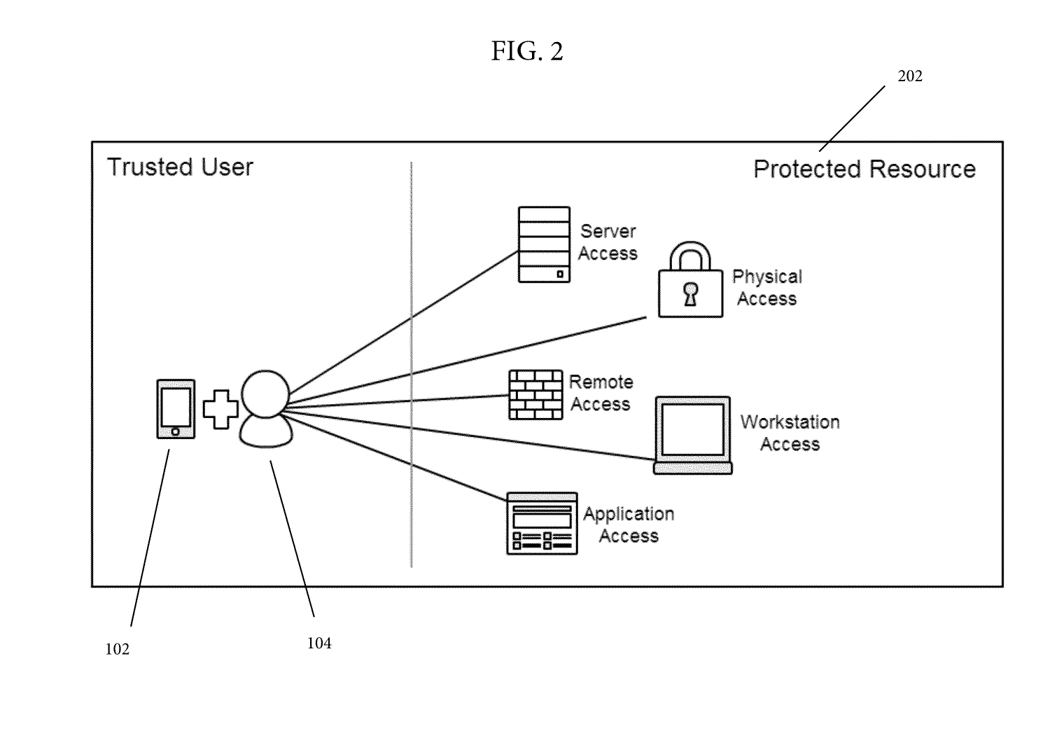

Protected Resources 202 may be end-user workstations, servers, network equipment, websites, remote access servers, physical locations, or any other system with the ability to connect to a network, as illustrated in FIG. 2.

Workstations are any computer system that end-users interact with directly. These may be laptops, desktops or thin clients. The solution is able to protect access to the Workstation, its data and its resources by requiring the presence of a Key Device 102 for general or specific operations. A software agent is installed on the workstation to help enforce access policies. Servers are networked equipment that provide a service. They are typically stationary. The solution's software agent can install on servers, and help enforce access policies. Networking equipment such as switches, routers, and firewalls may be configured to take advantage of this solution by using a RADIUS interface. Websites may control access by using RADIUS, SAML, web API, or customized authentication modules for IIS and Apache. Remote access servers may take advantage of this solution by using a RADIUS interface. Physical access can be monitored and controlled by monitoring for the presence of known Key Devices 102, and trigger the appropriate response. Responses can vary between showing a user record to security personnel to unlocking a door.

Enforcement points represent any controlled resource or location where the solution is in use. Enforcement points can be any networked host or service, a simple counter mechanism, or a workstation that displays user information to security personnel. Integration services allow the solution to integrate with other systems. Protected Resources 202 may interact with the solution through a number of standardized access methods such as, but not limited to, RADIUS, Web API, and SAML. Administration interfaces are provided for managing agent configuration, user accounts and physical security zones. Administration allows for access policies to be set, enforced and monitored.

The solution design includes software, hardware, and protocol. Software can include a workstation agent, Mobile Agent, access policy controller, and infrastructure. Hardware can include Key Devices 102 and infrastructure. Protocol can include agent-to-agent protocols, agent to infrastructure protocols, and workstation to infrastructure protocols.

The workstation agent software can be installed on any end-user workstation or server that requires protection. The Agent performs a number of functions depending on the configuration. The most important functions are integrating with the host, communicating with the Key Device 102, communicating with Access Policy Controllers and controlling the login process. The Agent also offers proximity-based automatic locking, OTP code generation, as well as local and remote configuration management.

The Mobile Agent software can optionally be installed on any approved Bluetooth device to enhance security and increase functionality. The Mobile Agent communicates with approved workstation agents, as well as other solution infrastructure. The Mobile Agent also provides an OTP soft token.

The Access Policy Controller software is a central component required for interaction with systems that are not part of the solution infrastructure. It provides account management, directory integration, RADIUS, SAML and Web-API interfaces to allow for a wide range of applications.

The software infrastructure consists of several components to allow for distributed detection and interaction with Key Devices 102. Access Points 602 are strategically placed to detect the presence of Key Devices 102. They may be placed at security checkpoints, access-controlled doors, or near the entrance to sensitive areas. Access Points 602 communicate with Key Devices 102, and pass their upstream communications to an Application Server. Application servers aggregate and control Access Point 602 and other local site communications and transmit them to the central components in the solution infrastructure to validate and verify Key Devices 102. They can also interface with local physical security resources, such as door locks and alarms. The master server is the central component that negotiates all communication and access decisions. It considers location, timing, identity and resources against a policy to determine what action should be taken by the presence of a detected secure device. Secure credential storage securely stores all key information required for mutual Key Device 102 authentication. All secured communications must access secure credential storage to validate endpoint identity. Management stations may be deployed at any location in the system. Depending on assigned roles and permissions, they may allow secure pairing of new devices, access policy management, identity and device review, and monitoring of device detection events.

Key Devices 102 can be almost any device that has wireless capabilities. For effective security, it is strongly recommended that the Key Device 102 be something the user carries at all times. Key Devices 102 capable of installing the Mobile Agent are capable of higher Security Assurance Levels. Common examples include, but are not limited to, mobile devices, Bluetooth headsets, and wireless beacons. Mobile devices can include, but are not limited to, mobile phones, smartphones, tablets, and music players. Any Bluetooth headset will work, but devices capable of multipoint connections are recommended. Wireless beacons are recommended for Users 104 without one of the devices above, or for use in situations where the devices above are not practical or allowed.

The solution does not require hardware, as most functions can be carried out on most commodity hardware with wireless capabilities. However, in certain instances, it is recommended or required to use specific hardware such as, but not limited to, Access Points 602 and access pads. Access Points 602 are small network-attached devices that can detect the presence of Key Devices 102. These are typically deployed for monitoring and physical access control. Access Pads are small network-attached devices with an alphanumeric keypad that may be used for physical access control or to receive input from a user for additional security.

As stated above, protocols can include agent-to-agent (A2A) protocols, agent to infrastructure (A2I) protocols, and workstation to infrastructure protocols. A2A communication is an optional feature set that extends assurance of validity between a Key Device 102 and a Workstation Agent. If the Key Device 102 has the Mobile Agent installed, the Mobile Agent can use enhanced secure data exchange inside the wireless connection. A2I communication is an optional feature set that extends assurance of validity between a Key Device 102 and the solution infrastructure. If a Key Device 102 has the Mobile Agent installed, the Mobile Agent can use enhanced secure data exchange inside the wireless connection. Workstation to infrastructure protocol, also referred to as Secure Request Verification (SRV), works by registering information about the trust relationship between a user and workstation with the Access Policy Server 302. When requests are made from this workstation to other resources, the resources may check the sent credentials and host information against the Access Policy Server 302 to verify if a request is coming from an approved user and workstation.

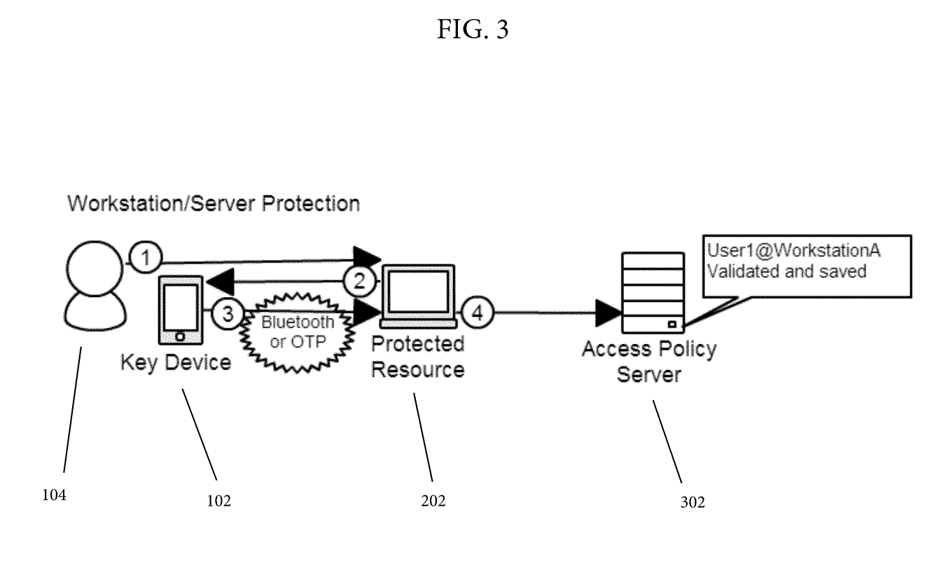

In one example of the process in use, as illustrated in FIG. 3, a user enters credentials and at least one Protected Resource 202 validates user credentials and checks for presence of Key Device 102. If Key Device 102 is found and validated, access is granted. In case of event of a lost or missing Key Device 102, access may be granted by way of additional challenge and response questions. Once access is approved, the account is registered with Access Policy Server 302 for use in Secure Request Verification. Since servers do not typically have or support local Bluetooth radios, access must be granted either via OTP or external Key Device 102 detection. In one embodiment, a user enters credentials and a OTP and a Protected Resource 202 validates information with the Access Policy Server 302. In another embodiment, an Access Point 602 detects the presence of Key Device 102 in a defined zone in which the Protected Resource 202 is located. The presence of Key Device 102 is registered with Access Policy Server 302. The User 104 then submits traditional credentials with Protected Resource 202, which sends access request to Access Policy Server 302 for approval.

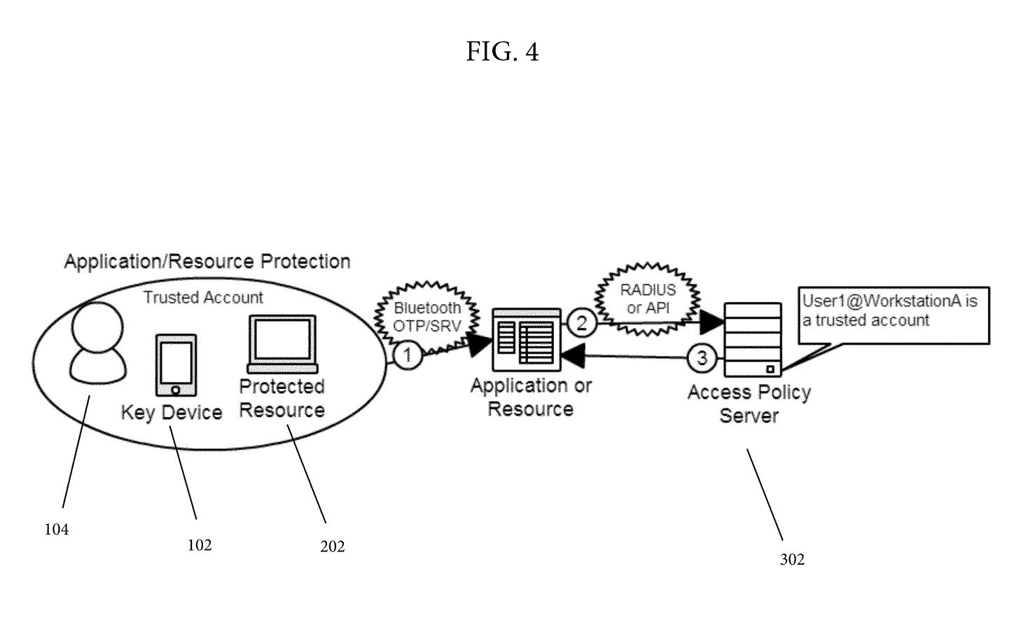

As illustrated in FIG. 4, the application and the network resources can be protected through Application Protection and Resource Protection. In one embodiment, Application Protection involves applications that may be configured to leverage the solution by altering them to use the Access Policy Server 302 in the authorization process. Applications may integrate with the Access Policy Server 302 in several ways, including, but not limited to, RADIUS, API, and SAML. RADIUS is a well-established standards-based AAA protocol. Applications can be altered to make calls to the solution API to integrate additional security into their authorization routines. SAML is another well-established security protocol for establishing and enforcing Access and Authorization.

When it comes to policy options, applications may require OTP codes to help validate identity, as illustrated in FIG. 4. OTP codes help establish a secondary credential in addition to the standard user password. Applications may also rely on Source Request Verification, as illustrated in FIG. 4, to reduce complexity in the authentication process. This process validates the request by validating the requesting user and workstation information against the Access Policy Server 302. A valid user/workstation session must be registered with the Access Policy Server 302 in order to approve the request. Network equipment may be configured to integrate with the RADIUS system on the Access Policy Server 302. Access policies may be configured in the same fashion as Application Protection described above.

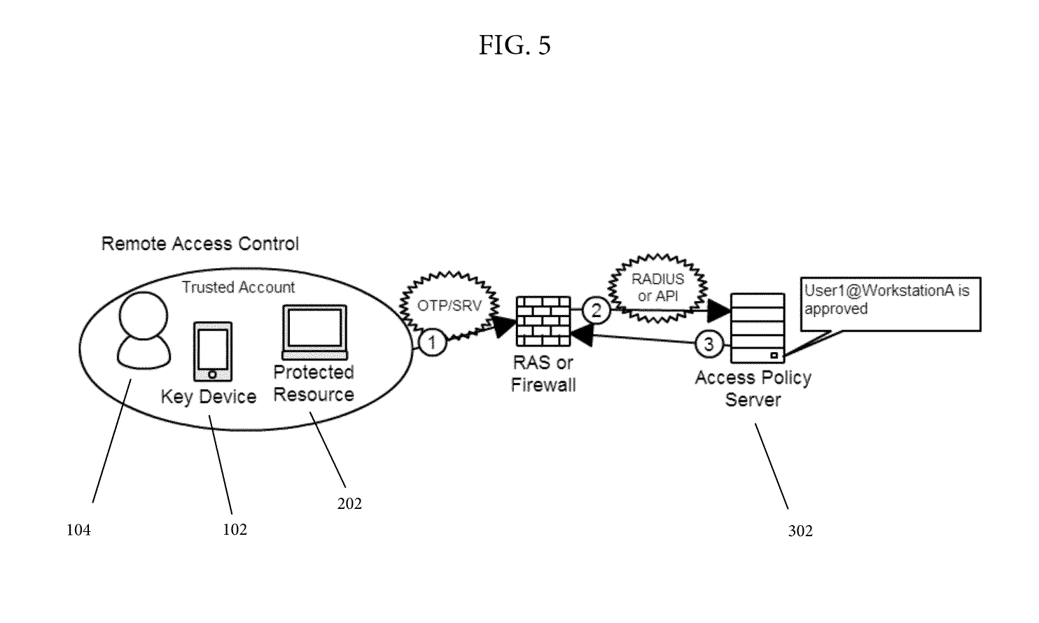

In one embodiment, remote access systems may be configured to integrate with the RADIUS system in the same manner as network Resource Protection 202 and Application Protection, as illustrated in FIG. 5.

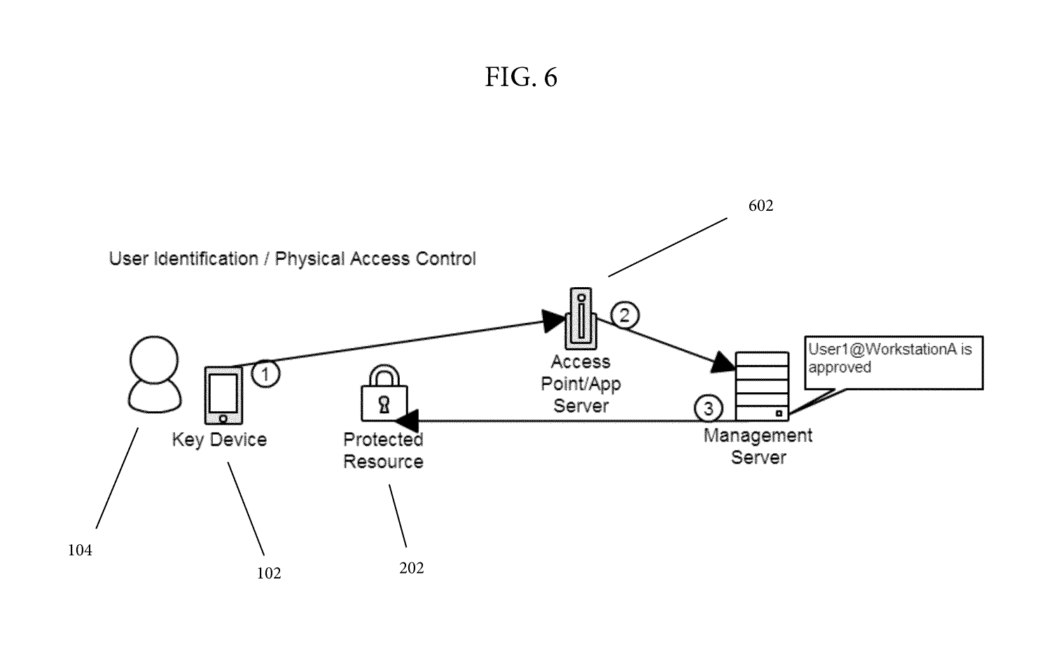

In one embodiment of a physical access control, as illustrated in FIG. 6, an Access Point 602 detects the presence of Key Device 102. If required, Access Pads may be implemented to require additional input from the user for increased security. Key Devices 102 running the Mobile Agent will further extend User 104 validation options. All input is forwarded to the local Application Server for assessment against the current policy. If all criteria are satisfied, the configured action(s) will be triggered. Triggered actions can be any number of events such as displaying a user record, notifying other systems, unlocking a door, or simply logging the event.

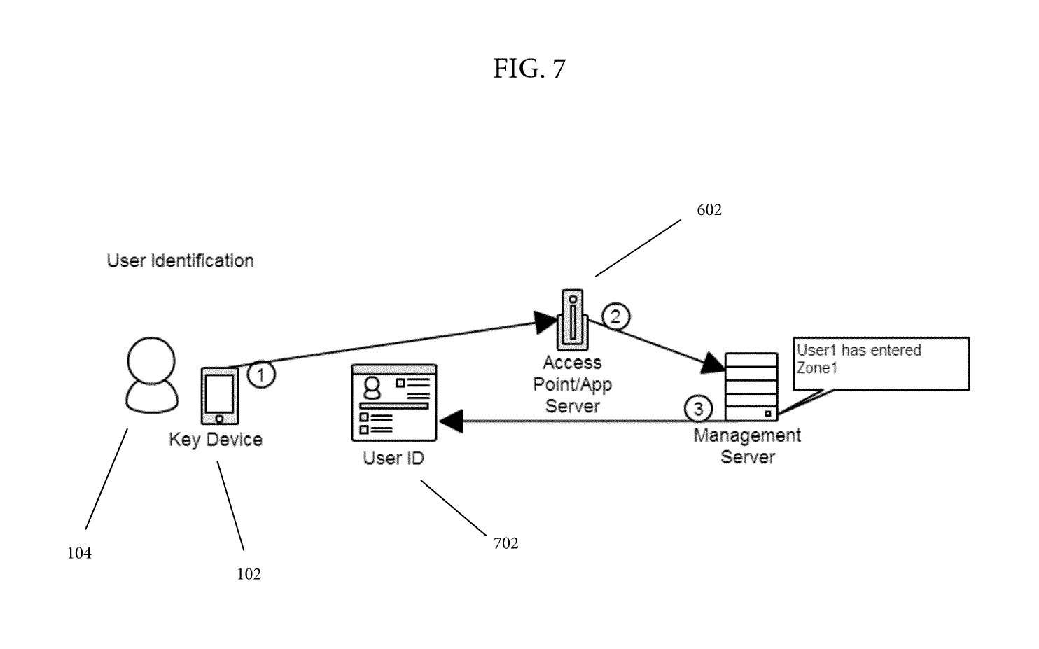

Similar to Physical Access Control, User Identification 702 uses Access Points 602 to detect registered Key Devices 102, as illustrated in FIG. 7. As an Access Point 602 detects the Key Device 102, the Application Server records the detection, and responds by interacting with other configured systems that track user presence. This design is intended to serve as a replacement for any instance when a user must identify themselves for commercial reasons. Examples include entrance to paid service providers like Gyms or loyalty programs at stores.

The following is a solution narrative:

User James recently bought a smart phone and would like to use this solution. James would like to secure his endpoint workstation, so while he is at home, he installs the Workstation Agent on his computer and the Mobile Agent on his phone. Next, he enrolls his phone as a Key Device with the Workstation Agent. James continues to log into his workstation as he always has with his domain credentials. When the Workstation Agent sees a username entered, it checks for the presence of a configured Key Device (his phone) via Bluetooth, NFC or Wi-Fi. If the computer does not detect the Key Device, login is denied. James also configured his workstation to lock if his Key Device is not found. So, later, when he goes to a coffee shop to work, his workstation automatically locks when he gets up to get a new cup of coffee.

When he returns, James realizes that there is a file he needs to access at work. Fortunately, he can self-enroll himself for remote access. Once he logs back in, James selects the “Enroll for OTP” option in his Workstation Agent configuration dialog. The Workstation agent walks him through enrolling the OTP soft token on his workstation. As soon as his has completed registration, an email is sent to Roberta, who is an administrator for James' company. The email tells Roberta that James has submitted a self-enrollment request. Roberta approves his request, and James receives an email with further instructions. Once complete, James visits his company's remote access portal. There, he enters his username, Domain password, and then double-clicks his Workstation Agent systray icon to copy the current OTP token code to his clipboard so he can paste it into the token code field of his login portal. The remote access gateway verifies James' credentials and grants him access to the resources he needs. Which at this time, is a file stored on the File-Sharing system.

Since Roberta has configured their File-Sharing system to use Secure Request Verification (SRV), the system has record that James is now on the network and that his Key Device is present. The SRV system tracks and records James' system and status while he is online. When James makes a request to access the file he needs, the File-Sharing system, the File-Sharing system sends the request information to the SRV system. The SRV system confirms that the host making the request is indeed James' workstation, and that James and his Key Device are present. The File-Sharing system then grants James access to his file. Now, he is all set for his presentation at work later that day.

When James arrives at his office, his phone is detected as he approaches the door. He pulls on the door to open it, but it is locked. He then remembers that he must enter his PIN into the numeric keypad on the side of the door. Once his PIN has been received, the door is unlocked, and James enters the office. As he enters, SRV records that James is now physically present at the office, and modifies the logical access policy to only allow requests from James' account to originate from internal networks. James gives his presentation and heads out after responding to some emails. One of these emails is from his wife asking him to stop by the store and pick up some milk and bread on the way home. As his Key Devices is detected leaving the office, the SRV access policy is modified prevent access with his account from internal networks.

James stops by the store and gets the milk and finds that there is a sale on bread with use of the store's loyalty card. Since James shops here quite frequently, he linked his Key Device to his loyalty account with the store. When he gets to the register, a sensor detects his Key Device at the checkout and the store's CRM system is alerted that James is at the register. The bread that is on sale requires a loyalty account, which is automatically linked to his store account.

This solution is designed to streamline the identification and verification process by leveraging a software and hardware based system to monitor and interact with common wireless devices or purpose-built beacons. The design allows for extended protection, fewer devices, and reduced user workload.

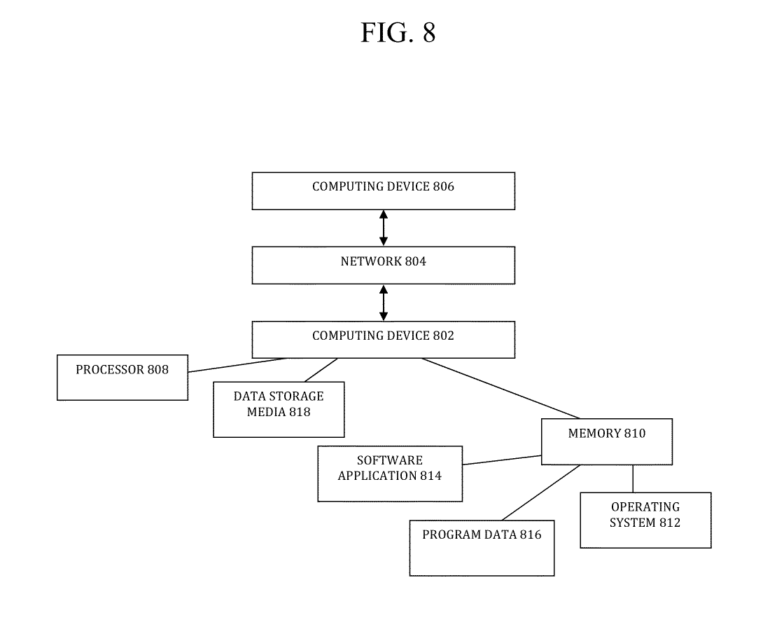

In general terms, the present disclosure relates to an online or mobile application that is executed using a computing system. FIG. 8 is a schematic block diagram of an example computing system 800.

The example computing system 800 includes at least one computing device 802. Computing device 802 can be, for example, a smart phone or other mobile device, a tablet computing device, a netbook, a computing device located in a user's home or in a care provider's office, or any other computing device. In some embodiments the computing system 800 further includes a communication network 804 (such as the internet or a cellular network) and one or more additional computing devices 806 (such as a server). Computing device 802 can be a stand-alone computing device or a networked computing device that communicates with one or more other computing devices 806 across network 804. Computing device 806 can be, for example, located remote from computing device 802, but configured for data communication with computing device 802 across a network 804. Computing device 806 can be, for example, a server.

In some examples, the computing device 802 or 806 includes at least one processor or processing unit 808 and system memory 810. Depending on the exact configuration and type of computing device, the system memory 810 may be volatile (such as RAM), non-volatile (such as ROM, flash memory, etc.) or some combination of the two. System memory 810 typically includes an operating system 812 suitable for controlling the operation of the computing device, such as the WINDOWS® operating systems from Microsoft Corporation of Redmond, Washington or a server, such as Windows SharePoint Server, also from Microsoft Corporation. To provide further example, if the computing device 802 is a smart phone or other mobile device, the operating system 812 may be iOS, WP7, or any other available mobile operating system. The system memory 810 may also include one or more software applications 814 and may include program data 816. The software applications 814 may be in the form of mobile applications in examples wherein the computing device 802 is a mobile device.

The computing device 802 may have additional features or functionality. For example, the device may also include additional data storage devices 818 (removable and/or non-removable) such as, for example, magnetic disks, optical disks, or tape. Computer storage media 818 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media 818 is non-transitory media. The computing device 806 may include data storage media such as the data storage media 818 described above, on which solution data is stored.

In some examples, one or more of the computing devices 802, 806 can be a smart phone or other mobile device. FIG. 8 includes a schematic diagram of such device. The computing device 802 may, for example, be a smart phone or other mobile device with input device options including, but not limited to, a keypad, a screen, a touch screen controller, and/or a touch screen. In other examples, the computing device can be a personal computing device that is networked to allow the user to access the system disclosed herein at a remote location, such as in a user's home, office or other location. In some embodiments, components of the system are stored as data instructions for a smart phone application.

A network 804 facilitates communication between the computing device 802 and one or more servers, such as computing device 806, that host the solution disclosed herein. The network 804 may be a wide variety of different types of electronic communication networks. For example, the network may be a wide-area network, such as the Internet, a local-area network, a metropolitan-area network, a cellular network or another type of electronic communication network. The network may also be a cellular network in some embodiments. The network may include wired and/or wireless data links. A variety of communications protocols may be used in the network 804 including, but not limited to, Ethernet, Transport Control Protocol (TCP), Internet Protocol (IP), Hypertext Transfer Protocol (HTTP), SOAP, remote procedure call protocols, and/or other types of communications protocols.

In some examples, computing device 806 is a Web server. In this example, computing device 802 includes a Web browser that communicates with the Web server to request and retrieve data. The data is then displayed to the user, such as by using a Web browser software application.

In some embodiments, the various operations, methods, and solutions disclosed herein are implemented by instructions stored in memory. When the instructions are executed by the processor of one or more of computing devices 802 and 806, the instructions cause the processor to perform one or more of the operations or methods disclosed herein. Examples of operations include installing workstation or Mobile Agents, configuring a Key Device, and locking an endpoint workstation.

The computing device 802 may include image capture devices, whether a dedicated video or image capture device, smart phone or other device that is capable of capturing images and video. Further, the system may include smart phones with native or web-based applications that can capture, store and transmit time-stamped video and images to a central server. The solution can also include location-data captured by a GPS-enabled application or device. The computing device 802 may also have WiFi or 3G capabilities.

I claim:

1. A system for managing user identification and authentication over a network, the system comprising:
a server, wherein the server is connected to a network and the server is programmed to store and recall user credential information and is further programmed to receive and evaluate at least one individual user identification or authentication request;
a wireless-enabled device that contains individual user credential information wherein the wireless-enabled device is capable of being paired with at least one computing device;
wherein the computing device is connected to the server and is programmed to detect the presence of the wireless-enabled device and is further programmed to send and receive information to and from the wireless-enabled device and to and from the server;
a comparison module on the server that is programmed to evaluate at least one individual user identification or authentication request based on individual user credential information, identifying information of the computing device and a location of the wireless-enabled device.
